(19) United States
(12) Patent Application Publication
(10) Pub. No.: US 2024/0020512 A1
(43) Pub. Date: Jan. 18, 2024

(54) Architecture Optimization of Deep Neural Networks by Capacity Adjustment of the Network Graph

(71) Applicant: Robert Bosch GmbH, Stuttgart (DE)

(72) Inventor: Jens Eric Markus Mehnert, Malmsheim (DE)

(21) Appl. No.: 18/256,382

(22) PCT Filed: Dec. 9, 2021
(86) PCT No.: PCT/EP2021/085041

§ 371 Date: Jun. 7, 2023

(30) Foreign Application Priority Data
Dec. 10, 2020 (DE) 10 2020 215 596.8

(51) Int. Cl. G06N 3/04; G06N 3/08

(52) U.S. Cl. CPC G06N 3/04; G06N 3/08

(57) ABSTRACT

A method for optimizing a network architecture of an artificial neural network includes determining resource needs of the network architecture of the artificial neural network as a function of a target hardware, and pruning the network architecture for obtaining a pruned network architecture. The resource needs of the pruned network architecture are smaller than the resource needs of the network architecture. The method further includes adding at least one connection to the pruned network architecture to obtain an expanded network architecture.

### PRIOR ART

For the industrial use of artificial neural networks, it is necessary to optimize the network architectures of the artificial neural networks to such an extent that they can be applied to hardware products as cheaply as possible. In the present case, applying it cheaply to a hardware product is understood to mean a measure that is to be considered in relation to the resources present on the hardware product, in particular computing resources.

Known methods for optimizing network architectures can be found under the term “architecture search”. Some of these methods use machine learning methods, such as the use of evolutionary algorithms or reinforcement learning.

Furthermore, it is known that the architecture search can be supported by network pruning.

### DISCLOSURE OF THE INVENTION

Against this background, the present invention creates a method for optimizing a network architecture of an artificial neural network.

The artificial neural network can be used for the classification of image data, for example.

The image data can be derived from detected sensor signals, for example. Sensors for electromagnetic waves, such as video, radar, and lidar sensors, for example, come into consideration as sensors.

The invention is based on the knowledge that the architecture search can be improved by means of network pruning by expanding the network architecture.

The reason for this is that layers whose evaluation results in the layers not (being able to) be (further) reduced give an indication that their respective capacity is too small. By adding connections, these layers can be expanded to increase the performance of networks, that is, essentially improving the quality of the results.

The method includes the following steps:
Determining the resource requirements of the network architecture of the artificial neural network as a function of target hardware.

Pruning the network architecture to obtain a pruned network architecture, the resource requirements of the pruned network architecture being less than the resource requirements of the network architecture.

The invention is characterized in particular by a step of adding network bindings.

In this case, in the adding step, at least one connection is added to the pruned network architecture in order to obtain an expanded network architecture.

The method of the present invention has the advantage that it can be used to easily determine an optimized network architecture for an artificial neural network whose resource needs are optimized in relation to the target hardware.

In the present case, target hardware is to be understood as meaning the hardware on which an artificial neural network with the optimized network architecture is to be executed. This is typically hardware that requires significantly less computing power than the hardware that is used to train the artificial network or to optimize the network architecture.

In the present context, pruning of the network architecture can be understood as meaning the current methods for pruning a network architecture. This includes structural pruning and pruning of weights or filters, among other things.

In the case of structural pruning, entire filters of a network layer are omitted and, in the extreme case in which a network layer no longer has a filter, the entire layer is removed.

When removing entire layers, it must be taken into account that there is still at least one path through the network from the input layer to the output layer after the removal.

When pruning weights, individual weights of a filter are discarded or set to zero.

Another term for pruning the network architecture is “network pruning”.

In the present context, adding (growing) a connection can be understood to mean that an additional layer is added to the network architecture. This layer can have a selection of typical filters that are used, for example, to classify image data. Another term for adding is “network growing”.

The addition can be carried out randomly or as a function of an internal or external measure. An internal measure can be understood as a measure that can be derived directly from the network architecture to be optimized. An external measure can be understood as a measure that can be derived without taking into account the network architecture to be optimized.

According to an embodiment of the method of the present invention, the method comprises a step of training the network architecture as a function of training data after the step of determining.

According to an embodiment of the method of the present invention, the method comprises an adding step after the step of adding connections. In this step, network filters are added to the expanded network architecture so that the resource requirements of the expanded network architecture correspond to the resource requirements of the network architecture.

According to an embodiment of the method of the present invention, the method comprises a final pruning step in order to obtain an optimized network architecture.

This embodiment is based on the recognition that the preceding embodiments can be applied iteratively. That is, the optimized network architecture can be fed back into the method and further optimized.

This optimization can be repeated until a limit value for a measure of optimization has been reached. Such a measure can be a relative or absolute resource consumption on the target hardware. A limit value for the progress of the optimization is also conceivable. The optimization can thus be terminated when the improvement over the previous step no longer meets a specified level. A predetermined number of iterations or a predetermined consumption of resources is also conceivable. Time, electricity/current, computing power, etc. can be considered as resources.

In contrast, the pruning step according to the last presented embodiment represents a final step, i.e. a step that ends the method.

A further aspect of the present invention is a computer program which is set up to carry out the method according to the present invention.

Another aspect of the present invention is a machine-readable storage medium on which the computer program according to the present invention is stored.

A further aspect of the present invention is a device which is set up to carry out the method according to the present invention.

Embodiments of the invention are explained in more detail in the following with reference to the accompanying drawings. The drawings show:

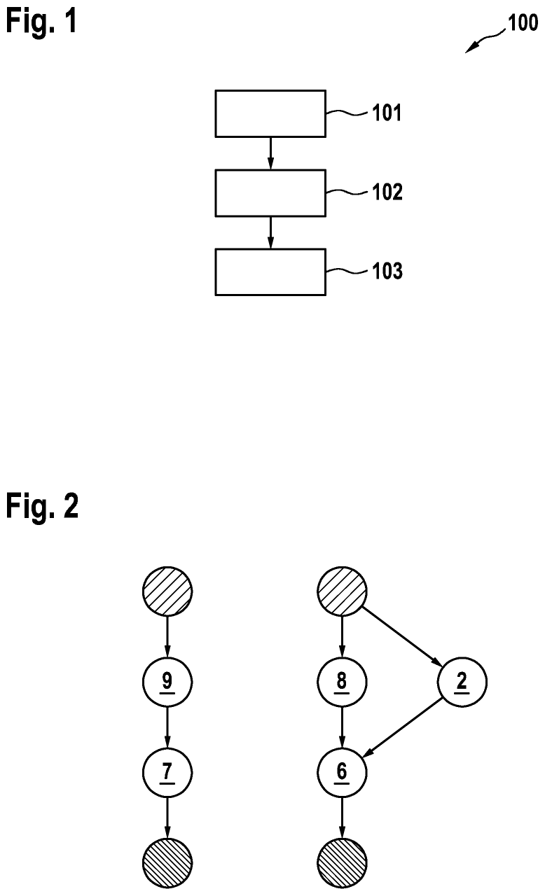

FIG. 1 a flowchart of an embodiment of the method according to the present invention;

FIG. 2 schematically shows an original and an optimized network architecture.

FIG. 1 shows a flowchart of an embodiment of the method 100 according to the present invention.

In step 101, the resource requirements of the network architecture of the artificial neural network are determined as a function of a target hardware.

The resource requirements of a network architecture depend on the target hardware on which the architecture is to be executed. A variable that can represent at least part of the resource requirements is the number of pixels to be processed in image processing applications, such as the classification of image data.

In step 102, the network architecture is pruned to obtain a pruned network architecture, wherein the resource requirements of the pruned network architecture are less than the resource requirements of the network architecture.

Various methods for pruning a network architecture are already known from the prior art. In the area of deep learning, layers-based (deep/multi-layer) networks are typically used. The methods known from the prior art for pruning network architecture are based on the evaluation of network parts. In the present case, network parts can be understood to mean network layers in layer-based artificial neural networks.

Thus, the present invention is based on the finding that layers whose evaluation results in the layers not (being able to) be (further) reduced can be expanded by adding connections in order to improve the performance of networks, i.e. essentially improving the quality of the results.

Therefore, the present invention features step 103. In step 103, at least one connection is added to the pruned network architecture to obtain an expanded network architecture.

As part of an expanded embodiment, in addition to adding at least one connection, connections without a filter can be deleted.

FIG. 2 schematically shows an original and an optimized network architecture.

The hatched nodes represent the input layers and the filled nodes represent the output layers of the respective network. The input and output layers are essentially defined by the given input and the desired output. Optimization therefore takes place primarily in the remaining (deep) layers of the network.

The unfilled nodes represent the (deep) layers (hidden layers) of the respective network. The numbers are resource points of the respective layer, which represent a resource consumption.

Both network architectures have the same resource consumption (16 resource points).

The network shown on the left represents the original network architecture. The network shown on the right represents a network architecture optimized by using the method of the present invention.

The resource requirements of the optimized network are not greater than the resource requirements of the original network. However, the optimized network has more connections. In the example shown, via a so-called skip connection with a resource requirement represented by 2. In addition, the resource requirements of the individual layers have been reduced. Once from 9 resource points to 8 resource points and once from 7 resource points to 6 resource points.

1. A method for optimizing a network architecture of an artificial neural network comprising:
determining the resource needs of the network architecture of the artificial neural network as a function of a target hardware;
pruning the network architecture for obtaining a pruned network architecture, resource needs of the pruned network architecture being smaller than the resource needs of the network architecture; and
adding at least one connection to the pruned network architecture to obtain an expanded network architecture.

2. The method according to claim 1, further comprising:
training the network architecture as a function of training data after the determining the resource needs of the network architecture.

3. The method according to claim 1, further comprising:
adding network filters to the expanded network architecture such that resources required by the expanded network architecture correspond to resources required by the network architecture.

4. The method according to claim 1, further comprising:
pruning the expanded network architecture in order to obtain an optimized network architecture.

5. The method according to claim 1, wherein a computer program is configured to carry out the method.

6. The method according to claim 5, wherein the computer program is stored on a non-transitory machine-readable storage medium.

7. The method according to claim 1, wherein a device is configured to carry out the method.
